(19) United States
(12) Patent Application Publication
(10) Pub. No.: US 2023/0163491 A1
(43) Pub. Date: May 25, 2023

(54) CONNECTOR

(71) Applicants: TOYOTA JIDOSHA KABUSHIKI KAISHA, Aichi-ken (JP); YAZAKI CORPORATION, Tokyo (JP)

(72) Inventors: Katsuhide KITAGAWA, Seto-shi (JP); Michihiro ISHIHARA, Makinohara-shi (JP)

(21) Appl. No.: 18/058,270

(22) Filed: Nov. 23, 2022

(30) Foreign Application Priority Data
Nov. 24, 2021 (JP) 2021-190551

(51) Int. Cl. H01R 9/24; H02K 5/22; H01R 4/70

(52) U.S. Cl. CPC H01R 9/2425; H02K 5/225; H01R 4/70

(57) ABSTRACT

A connector including: (a) a terminal block; (b) an elongated busbar which is inserted in an insertion hole provided in the terminal block so as to be held by the terminal block in a cantilever manner; (c) a seal member which is disposed between the busbar and a wall surface of the insertion hole and which closes a gap defined between the busbar and the wall surface of the insertion hole; and (d) a protection member which is disposed in the gap defined between the busbar and the wall surface of the insertion hole and which is located between the seal member and an opening of the insertion hole.

### CONNECTOR

This application claims priority from Japanese Patent Application No. 2021-190551 filed on Nov. 24, 2021, the disclosure of which is herein incorporated by reference in its entirety.

### FIELD OF THE INVENTION

The present invention relates to a connector for connecting between an electrical equipment and a power line cable through which an electric power is to be supplied to the electrical equipment.

### BACKGROUND OF THE INVENTION

There is known a connector for connecting between an electrical equipment and a power line cable. A connector disclosed in JP2021-89881A is an example of such a connector. This Japanese Patent Application Publication discloses that busbars are inserted in respective insertion holes provided in a terminal block (called “housing” in this Publication) of the connector, and that a seal member is disposed between each of the busbars and a wall surface of a corresponding one of the insertion holes.

### SUMMARY OF THE INVENTION

By the way, in a construction, as shown in the above-identified Japanese Patent Application Publication, in which the busbars are inserted in the respective insertion holes provided in the terminal block, and in which the seal member is disposed between each of the busbars and the wall surface of the corresponding one of the insertion holes, if vibration generated in the electrical equipment is transmitted to each busbar via the corresponding power line cable, the busbar is vibrated in the corresponding insertion hole whereby load applied to the busbar is increased. The increase of the load applied to the busbar causes a risk that durability of the busbar could be reduced. Further, the vibration of the busbar makes it difficult to ensure sufficient squeeze (i.e., amount of compression) of the seal member, thereby causing risks that oil could leak through the seal member and that water could enter through the seal member.

The present invention was made in view of the background art described above. It is therefore an object of the present invention to provide a connector including: a terminal block; a busbar inserted in an insertion hole of the terminal block; a seal member disposed between the busbar and the insertion hole, wherein the connector is capable of reducing load applied the busbar due to vibration of the busbar, and suppressing leakage of oil through the seal member and entrance of water through the seal member.

The object indicated above is achieved according to the following aspects of the present invention.

According to a first aspect of the invention, there is provided a connector including: (a) a terminal block; (b) an elongated busbar which is inserted in an insertion hole provided in the terminal block so as to be held by the terminal block in a cantilever manner; (c) a seal member which is disposed between the busbar and a wall surface of the insertion hole and which closes a gap defined between the busbar and the wall surface of the insertion hole; and (d) a protection member which is disposed in the gap defined between the busbar and the wall surface of the insertion hole and which is located between the seal member and an opening of the insertion hole.

According to a preferred arrangement of the first aspect of the invention, the protection member is made of a material that is more rigid than a material of which the seal member is made.

Further, according to another preferred arrangement of the first aspect of the invention, the busbar is an elongated plate member that is inserted in the seal member and the protection member each of which has a generally annular shape, wherein the protection member has an outside dimension that is smaller than a dimension of the insertion hole in which the seal member is fitted, each of the outside dimension of the protection member and the dimension of the insertion hole being a dimension measured in a thickness direction of the busbar that is the elongated plate member.

According to a second aspect of the invention, in the connector according to the first aspect of the invention, there is further provided a nut having a surface in which a threaded hole is provided, wherein the nut is press-fitted in the terminal block and is located on a side of the opening of the insertion hole, such that the surface of the nut is in contact with the busbar.

According to a third aspect of the invention, in the connector according to the second aspect of the invention, the protection member includes a projecting portion projecting toward the nut that is located on the side of the opening of the insertion hole.

According to a fourth aspect of the invention, in the connector according to any one of the first through third aspects of the invention, the protection member is made of resin.

According to a fifth aspect of the invention, in the connector according to any one of the first through fourth aspects of the invention, the busbar is to be connected to a power line cable extending from a stator of a rotary electric machine.

In the connector according to the first aspect of the invention, the protection member is disposed in the gap defined between the busbar and the wall surface of the insertion hole and which is located between the seal member and an opening of the insertion hole. Therefore, even when vibration generated in an electrical equipment is transmitted to the busbar, amount of deformation of the busbar is limited owing to contact of the busbar with the protection member. Consequently, load applied to the busbar is reduced so that it is possible to suppress reduction of durability of the busbar. Moreover, since the amount of deformation of the busbar is limited upon vibration of the busbar, it is possible to ensure sufficient squeeze of the seal member, thereby suppressing leakage of oil through the seal member and also entrance of water through the seal member.

In the connector according to the second aspect of the invention, the nut is press-fitted in the terminal block and is located on the side of the opening of the insertion hole, such that the surface (in which the threaded hole is provided) of the nut is in contact with the busbar. Therefore, with a bolt being provided to penetrate through the busbar so as to be screwed in the nut, it is possible to easily fix an end portion of the busbar to the terminal block.

In the connector according to the third aspect of the invention, the protection member includes a projecting portion projecting toward the nut that is located on the side of the opening of the insertion hole, such that a distal end of the projecting portion can be brought into contact with the nut. Therefore, with the projecting portion being brought into contact with the nut, movement of the protection member toward the opening of the insertion hole is limited. Further, regarding the seal member disposed between the protection member and a bottom of the insertion hole, too, its movement toward the opening of the insertion hole is limited, so that the seal member is prevented from being removed out of the insertion hole.

In the connector according to the fourth aspect of the invention, the protection member is made of resin, so that it is possible to prevent the seal member being damaged by the protection member when the protection member and the seal member are brought into contact with each other.

In the connector according to the fifth aspect of the invention, when vibration is generated upon operation of the rotary electric machine and the vibration is transmitted to the busbar via the power line cable extending from the stator, the busbar is vibrated but the amount of deformation of the busbar is limited by the protection member.

### BRIEF DESCRIPTION OF THE DRAWINGS

FIG. 1 is a view showing an internal structure of a vehicle power transmission device to which the present invention is applied;

FIG. 2 is a perspective view showing a connector and a stator of a rotary electric machine that are shown in FIG. 1;

FIG. 3 is an overall view showing the connector, as seen in a direction in which bolts are screwed;

FIG. 4 is a perspective view showing, in enlargement, a part of the connector;

FIG. 5 is a cross-sectional view taken in line B-B (that passes through a busbar) in FIG. 3;

FIG. 6 is a view showing the cross-sectional view of FIG. 5, in a perspective manner;

FIGS. 7A and 7B are views showing the busbar, a nut, a packing seal and a holder that are extracted from FIG. 6; and

FIG. 8 is a cross sectional view showing, in enlargement, a first extending portion that is shown in FIG. 5.

### DETAILED DESCRIPTION OF PREFERRED EMBODIMENT

Hereinafter, there will be described preferred embodiment in detail with reference to the accompanying drawings. It is noted that figures of the drawings are simplified or deformed as needed, and each portion is not necessarily precisely depicted in terms of dimension ratio, shape, etc. EMBODIMENT

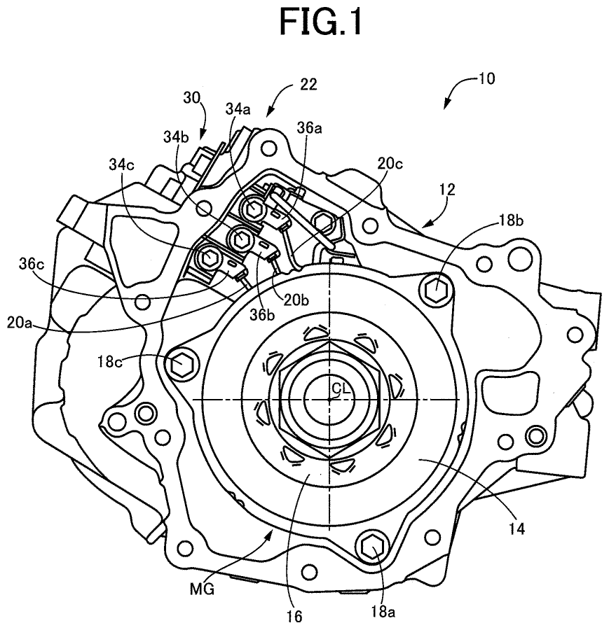

FIG. 1 is a view showing an internal structure of a vehicle power transmission device 10 to which the present invention is applied. As shown in FIG. 1, a rotary electric machine MG is stored inside a casing 12 of the vehicle power transmission device 10.

The rotary electric machine MG includes a stator 14 and a rotor 16 that is disposed on an inner peripheral side of the stator 14. The stator 14 is fixed to the casing 12 through three bolts 18a-18c. The rotor 16 is held by the casing 12 and is rotatable about an axis CL.

The vehicle power transmission device 10 includes a connector 22 provided to electrically connect between an inverter (not shown) and three stator power line cables 20a-20c (power line cables) extending from the stator 14. It is noted that each of the stator power line cables 20a-20c corresponds to “power line cable” recited in the appended claims.

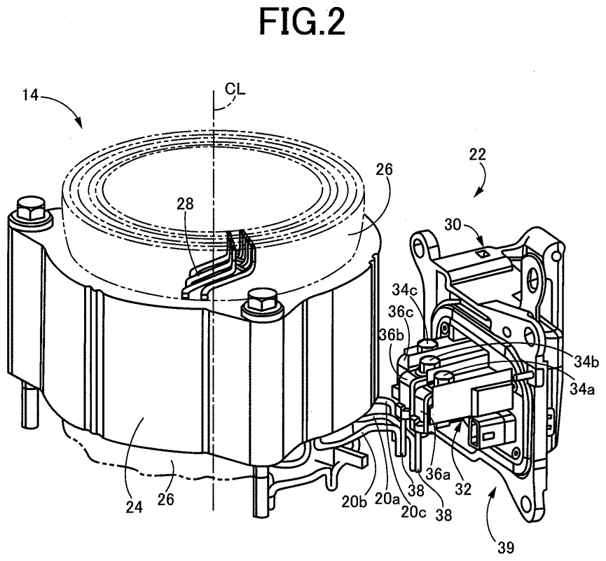

FIG. 2 is a perspective view showing the connector 22 and the stator 14 of the rotary electric machine MG that are shown in FIG. 1.

The stator 14 includes an annular-shaped stator core 24 and stator coils 26 that protrude from an axially opposite ends of the stator core 24, i.e., opposite ends of the stator core 24 that are opposite to each other in a direction of the axis CL. The stator core 24 is constituted by a plurality of disc-shaped electromagnetic steel sheets that are laminated on each other. The stator coils 26 are constituted by a plurality of segments 28 that pass through slots (not shown) that are provided in the stator core 24. Each of the slots extends radially from an inner circumferential surface of the stator core 24 toward an outer peripheral side of the stator core 24, and penetrates the stator core 24 in the direction of the axis CL. Each of the segments 28 has a U-shape, for example, and passes through a corresponding one of the slots from one of axially opposite sides (i.e., opposite sides in the direction of the axis CL) of the stator core 24 to the other of the axially opposite sides of the stator core 24. Further, each of the segments 28 is connected at its end portion with another of the segments 28 in the other of the axially opposite sides of the stator core 24 . . . It is noted that, in FIG. 2, some of the segments 28 are shown while the other segments 28 are not shown.

The connector 22 is provided to connect between the stator power line cables 20a-20c (extending from the stator 14) and power-supply line cables (not shown) extending from the inverter. The connector 22 includes: a connector housing 30 as a casing body; a connector main body 32 disposed inside the housing 30; and three plates 36a-36c (hereinafter simply referred to as “plates 36” unless they are to be distinguished from one another) that are fixed to the connector main body 32 through respective three bolts 34a-34c (hereinafter simply referred to as “bolts 34” unless they are to be distinguished from one another). The connector main body 32 cooperates with the housing 30 covering the connector main body 32, to constitute a terminal block 39.

The housing 30 is made of aluminum alloy, for example, and is fixedly disposed outside the casing 12. The connector main body 32 is made of resin, and is disposed inside the housing 30. Each of the plates 36 has an L shape, and is fixed to the connector main body 32 through a corresponding one of the bolts 34. Elongated intermediate members 38 are connected to the respective plates 36 by suitable means such as caulking. The stator power line cables 20a-20c are connected at their distal end portions with distal end portions of the respective intermediate members 38 by suitable means such as welding, so that the stator power line cables 20a-20c are electrically connected to the respective plates 36a-36c.

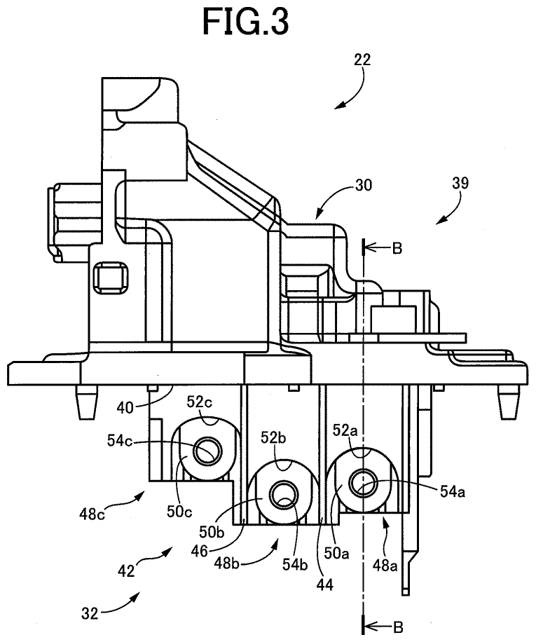

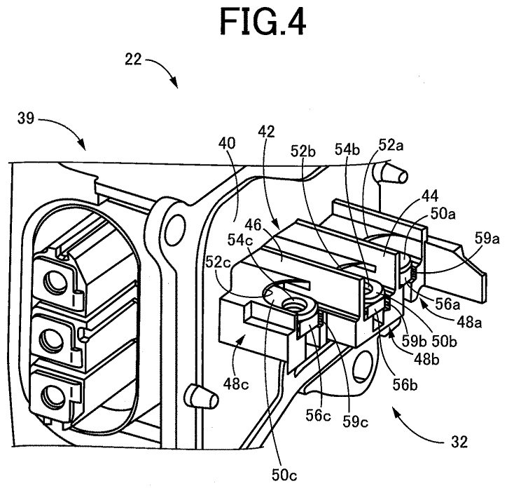

FIG. 3 is an overall view showing the connector 22, as seen in a direction in which the bolts 34 are screwed. FIG. 4 is a perspective view showing, in enlargement, a part of the connector 22, wherein the part of the connector 22 includes a portion of the connector 22 in which busbars 50a-50c protrude. It is noted that the bolts 34 and the plates 36 shown in FIG. 2 are not shown in FIGS. 3 and 4.

As shown in FIG. 3, the connector main body 32 is substantially covered by the housing 30 so as to be protected by the housing 30. The housing 30 is disposed outside the casing 12 in an assembled state in which the connector 22 is assembled in the vehicle power transmission device 10. The casing 12 has a rectangular-shaped through-hole that communicates between an inner space and an outer space, and the terminal block 39 is fixed to the casing 12 such that the rectangular-shaped through-hole is closed by the terminal block 39. With the terminal block 39 being fixed to the casing 12, a peripheral end of the housing 30 is in contact with a surrounding portion of an outer wall surface of the casing 12, which surrounds the above-described rectangular-shaped through-hole, so that an extending portion 42 extending from a surface 40 of the connector main body 32 is located in the inner space of the casing 12.

The connector main body 32, which is made of the resin, has the surface 40 from which the extending portion 42 extends perpendicularly to the surface 40. In the assembled state in which the connector 22 is assembled in the vehicle power transmission device 10, the surface 40 of the connector main body 32 faces the inner space of the casing 12, so that the extending portion 42 is located in the inner space of the casing 12.

The extending portion 42 includes first through third extending portions 48a-48c, wherein the first and second extending portions 48a, 48b are separated from each other by a first partition wall 44 that extends from the surface 40 perpendicularly to the surface 40, and the second and third extending portions 48b, 48c are separated from each other by a second partition wall 46 that extends from the surface 40 perpendicularly to the surface 40. The first through third extending portions 48a-48c have respective insertion holes 58 in which the respective busbars 50a-50c are inserted.

Each of the busbars 50a-50c is an elongated member constituted by a plate member that is made of copper, for example. The connector main body 32 is formed, by an insert forming process, in a state in which the busbars 50a-50c are inserted in the respective insertion holes 58.

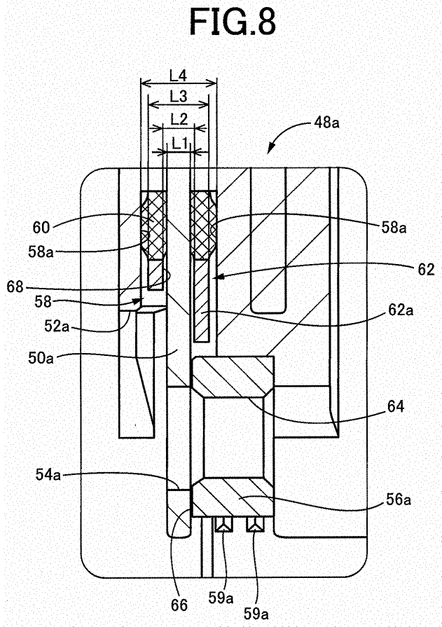

A cutout 52a is provided in a bolt-receiving portion of the first extending portion 48a in which the bolt 34a is received, such that an end portion of the busbar 50a is exposed through the cutout 52a from the insertion hole 58 of the first extending portion 48a. The end portion of the busbar 50a is provided with a through-hole 54a thought which the bolt 34a is to pass. A nut 56a is provided on a side of an opening of the insertion hole 58, such that the nut 56a is in contact with the end portion of the busbar 50a in which the through-hole 54a is provided. More specifically, with the nut 56a being fixed in a predetermined position in the first extending portion 48a, the busbar 50a is in contact with a surface 66 (see FIG. 8) of the nut 56a, such that the through-hole 54a of the busbar 50a overlaps with a threaded hole 64 (see FIG. 8) that is provided in the surface 66, namely, an axis of the through-hole 54a is substantially aligned with an axis of the threaded hole 64. The surface 66 of the nut 56a is defined as one of opposite end surfaces of the nut 56a that are opposite to each other in an axial direction of the threaded hole 64, wherein the one of the opposite end surfaces is opposed to the busbar 50a.

The nut 56a has a rectangular outer shape, and is disposed in a space located on one of opposite sides of the busbar 50a that is remote from the bolt 34a, so that the bolt 34a is screwed in the threaded hole 64 of the nut 56a. The nut 56a is fixed in the first extending portion 48a constituting a part of the terminal block 39, with two side surfaces of the nut 56a being press-fitted in respective surfaces of the first extending portion 48a, wherein the two side surfaces are parallel to the first and second partition walls 44, 46. The surfaces of the first extending portion 48a, in which the two side surfaces of the nut 56a being press-fitted, are provided with stopper protrusion portions 59 a for inhibiting displacement of the press-fitted nut 56a relative to the first extending portion 48a. The bolt 34a is screwed in the nut 56a, with the bolt 34b passing through the through-hole 54a of the busbar 50a and a through-hole (not shown) of the plate 36a, whereby the busbar 50a and the plate 36a are integrally fixed to each other. Thus, the busbar 50a is connected through the plate 36a to the stator power line cable 20a that extend from the stator 14 of the rotary electric machine MG.

A cutout 52b is provided in a bolt-receiving portion of the second extending portion 48b in which the bolt 34b is received, such that an end portion of the busbar 50b is exposed through the cutout 52b from the insertion hole 58 of the second extending portion 48b. The end portion of the busbar 50b is provided with a through-hole 54b thought which the bolt 34b is to pass. A nut 56b is provided on a side of an opening of the insertion hole 58, such that the nut 56b is in contact with the end portion of the busbar 50b in which the through-hole 54b is provided. More specifically, with the nut 56b being fixed in a predetermined position in the second extending portion 48b, the busbar 50b is in contact with a surface of the nut 56b, such that the through-hole 54b of the busbar 50b overlaps with a threaded hole that is provided in the surface of the nut 56b, namely, an axis of the through-hole 54b is substantially aligned with an axis of the threaded hole.

The nut 56b has a rectangular outer shape, and is disposed in a space located on one of opposite sides of the busbar 50b that is remote from the bolt 34b, so that the bolt 34b is screwed in the threaded hole of the nut 56b. The nut 56b is fixed in the second extending portion 48b constituting a part of the terminal block 39, with two side surfaces of the nut 56b being press-fitted in respective surfaces of the second extending portion 48b, wherein the two side surfaces are parallel to the first and second partition walls 44, 46. The surfaces of the second extending portion 48b, in which the two side surfaces of the nut 56b being press-fitted, are provided with stopper protrusion portions 59b for inhibiting displacement of the press-fitted nut 56b relative to the second extending portion 48b. The bolt 34b is screwed in the nut 56b, with the bolt 34b passing through the through-hole 54b of the busbar 50b and a through-hole (not shown) of the plate 36b, whereby the busbar 50b and the plate 36b are integrally fixed to each other. Thus, the busbar 50b is connected through the plate 36b to the stator power line cable 20b that extend from the stator 14 of the rotary electric machine MG.

A cutout 52c is provided in a bolt-receiving portion of the third extending portion 48c in which the bolt 34c is received, such that an end portion of the busbar 50c is exposed through the cutout 52c from the insertion hole 58 of the third extending portion 48c. The end portion of the busbar 50c is provided with a through-hole 54c thought which the bolt 34c is to pass. A nut 56c is provided on a side of an opening of the insertion hole 58, such that the nut 56c is in contact with the end portion of the busbar 50c in which the through-hole 54c is provided. More specifically, with the nut 56c being fixed in a predetermined position in the third extending portion 48c, the busbar 50c is in contact with a surface of the nut 56c, such that the through-hole 54c of the busbar 50c overlaps with a threaded hole that is provided in the surface of the nut 56c, namely, an axis of the through-hole 54c is substantially aligned with an axis of the threaded hole.

The nut 56c has a rectangular outer shape, and is disposed in a space located on one of opposite sides of the busbar 50c that is remote from the bolt 34c, so that the bolt 34c is screwed in the threaded hole of the nut 56c. The nut 56c is fixed in the third extending portion 48c constituting a part of the terminal block 39, with two side surfaces of the nut 56c being press-fitted in respective surfaces of the third extending portion 48c, wherein the two side surfaces are parallel to the first and second partition walls 44, 46. The surfaces of the third extending portion 48c, in which the two side surfaces of the nut 56c being press-fitted, are provided with stopper protrusion portions 59c for inhibiting displacement of the press-fitted nut 56c relative to the third extending portion 48c. The bolt 34c is screwed in the nut 56c, with the bolt 34c passing through the through-hole 54c of the busbar 50c and a through-hole (not shown) of the plate 36c, whereby the busbar 50c and the plate 36c are integrally fixed to each other. Thus, the busbar 50c is connected through the plate 36c to the stator power line cable 20c that extend from the stator 14 of the rotary electric machine MG.

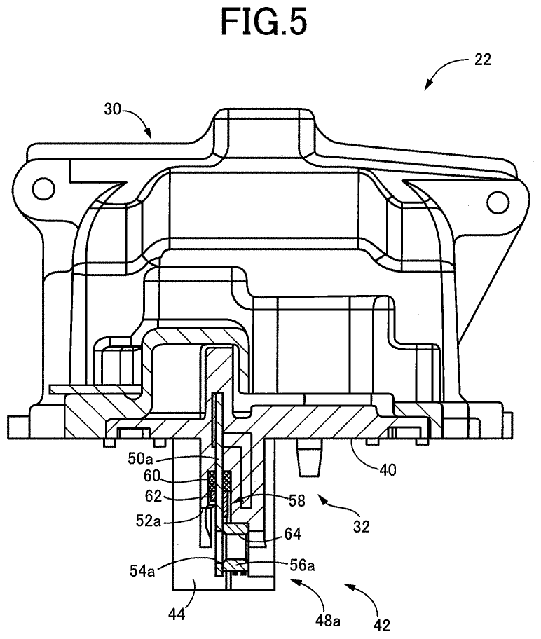

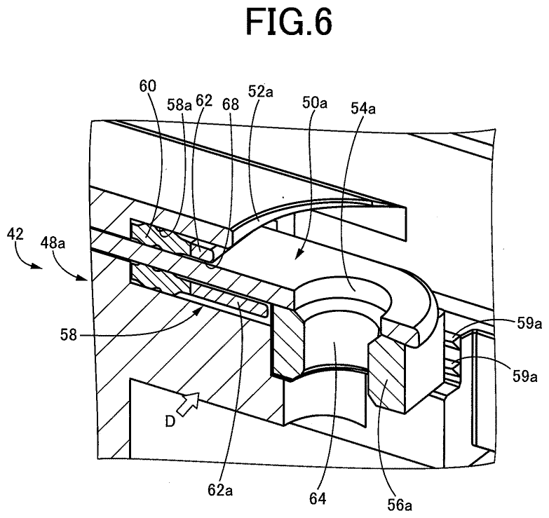

FIG. 5 is a cross-sectional view taken in line B-B (that passes through a widthwise center of the busbar 50a) in FIG. 3 that shows the connector 22. FIG. 6 is a view showing the cross-sectional view of FIG. 5, in a perspective manner As shown in FIGS. 5 and 6, the first extending portion 48a extending from the surface 40 of the connector main body 32 is provided with the insertion hole 58 that is perpendicular to the surface 40, and the busbar 50a is inserted in the insertion hole 58. Thus, the busbar 50a is held by the connector main body 32 in a cantilever manner

The insertion hole 58 is provided to surround the busbar 50a. In the insertion hole 58, a packing seal 60 as well as the busbar 50a is inserted, such that the packing seal 60 is provided in an annular gap between the busbar 50a and a wall surface 58a of the insertion hole 58, so as to close the annular gap. The packing seal 60 is placed adjacent to a bottom of the insertion hole 58. With the packing seal 60 being provided in the insertion hole 58, it is possible to suppress leakage of oil stored in the inner space of the casing 12 toward the outer space, and also entrance of water to the inner space of the casing 12 from the outer space. It is noted that the packing seal 60 corresponds to “seal member” recited in the appended claims. A holder 62 described below does not have a sealing function.

From a state shown in FIGS. 5 and 6 in which the busbar 50a is superposed on the nut 56a, the plate 36a is superposed on the busbar 50a, and then the bolt 34a is screwed in the nut 56a, whereby the busbar 50a and the plate 36a are integrally fixed to each other. The busbar 50a is made of a copper material while the nut 56a is made of an iron material, so that the busbar 50a and the nut 56a are different from each other in terms of coefficient of linear expansion. Therefore, at an extremely low temperature, a gap is formed between the busbar 50a and the nut 56a due to the difference in the coefficient of linear expansion, so that the busbar 50a is vibrated if vibration generated in the stator 14 during operation of the rotary electric machine MG is transmitted to the busbar 50a via the stator power line cable 20a and the plate 36a. If the busbar 50a is vibrated, the busbar 50a is repeatedly deformed whereby load is applied to the busbar 50a thereby causing a risk that durability of the busbar 50a could be reduced. Moreover, during vibration of the busbar 50a, if the packing seal 60 closing the gap between the busbar 50a and the wall surface 58a of the insertion hole 58 is not sufficiently squeezed in a portion thereof, there are risks that oil could leak outwardly through the portion of the packing seal 60 and that water could enter the inner space of the casing 12 through the portion of the packing seal 60.

On the other hand, in the present embodiment, a holder 62 is disposed in the gap defined in the insertion hole 58, i.e., defined between the busbar 50a and the wall surface 58a of the insertion hole 58, so as to limit amount of deformation of the busbar 50a when the busbar 50a is vibrated. The holder 62 is made of resin or other material more rigid than a material of which the packing seal 60 is made, and is disposed between the packing seal 60 and the nut 56a in the insertion hole 58. That is, the holder 62 is disposed between the packing seal 60 and the opening of the insertion hole 58 in the insertion hole 58. The holder 62 as well as the packing seal 60 is shaped to surround the busbar 50a. It is noted that, although the packing seal 60 and the holder 62 are contiguous to each other in a longitudinal direction of the busbar 50a, i.e., a longitudinal direction of the insertion hole 58 in FIGS. 5 and 6, the holder 62 is movable relative to the packing seal 60 in the longitudinal direction of the busbar 50a, i.e., the longitudinal direction of the insertion hole 58. It is also noted that the holder 62 corresponds to “protection member” recited in the appended claims.

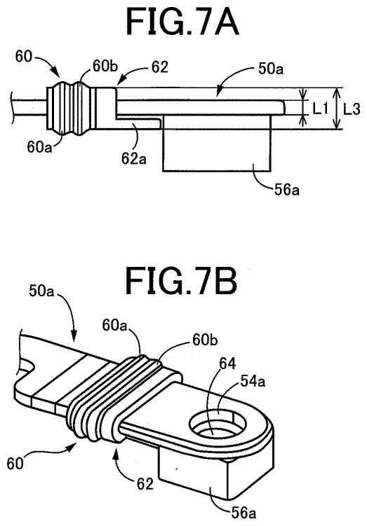

FIGS. 7A and 7B are views showing the busbar 50a, nut 56a, packing seal 60 and holder 62 that are extracted from FIG. 6, wherein FIG. 7A is a view of the busbar 50a, nut 56a, packing seal 60 and holder 62 as seen in direction of arrow D, and FIG. 7B is a perspective view of FIG. 7A. As shown in FIGS. 7A and 7B, the packing seal 60 has a generally annular shape so as to surround the busbar 50a. The packing seal 60 has a through-hole having a rectangular shape in its cross section, such that the busbar 50a is inserted in the through-hole of the packing seal 60. The packing seal 60 presses the busbar 50a that is inserted in the through-hole of the packing seal 60, so that the busbar 50a and the packing seal 60 are in close contact with each other.

The packing seal 60, which is inserted in the insertion hole 58, is provided with annular protrusions 60a, 60b protruding outwardly. The protrusions 60a, 60b are in contact with the wall surface 58a of the insertion hole 58, and are deformed or squeezed whereby the gap between the busbar 50a and the wall surface 58a of the insertion hole 58 is closed by the packing seal 60.

The holder 62 as well as the packing seal 60 is shaped to surround the busbar 50a. The holder 62 has a through-hole 68 (see FIGS. 6 and 8) having a rectangular shape in its cross section, such that the busbar 50a is inserted in the through-hole 68 of the holder 62 as well as in the above-described through-hole of the packing seal 60. The busbar 50a has a dimension L1 that is slightly smaller than a dimension L2 of the through-hole 68 of the holder 62 (L1<L2), wherein each of the dimensions L1, L2 is a dimension measured in a thickness direction of the busbar 50a (see FIG. 8). Therefore, the holder 62 is allowed to be moved relative to the busbar 50a in the longitudinal direction of the busbar 50a.

Further, the holder 62 has an outside dimension L3 that is smaller than a dimension L4 between mutually opposed portions of the wall surface 58a of the insertion hole 58 (L3<L4), wherein each of the dimensions L3, L4 is a dimension measured in a thickness direction of the busbar 50a (see FIG. 8). Therefore, a small gap is defined between the wall surface 58a of the insertion hole 58 and the holder 62 that is inserted in the insertion hole 58.

The holder 62 includes a projecting portion 62a toward the nut 56a such that a distal end of the projecting portion 62a is contactable with the nut 56a. The projecting portion 62a is located in a position in which the distal end of the projecting portion 62a is contactable with the nut 56a. The distal end of the projecting portion 62a is located in vicinity to the nut 56a. Therefore, even in a case in which the holder 62 is moved toward the nut 56a, the movement of the holder 62 toward the nut 56a is limited by contact of the distal end of the projecting portion 62a with the nut 56a.

FIG. 8 is a cross sectional view showing, in enlargement, the first extending portion 48a that is shown in FIG. 5. In a process of manufacturing the connector 22, the packing seal 60 and the holder 62 are inserted into the insertion hole 58 before the nut 56a is press-fitted into the first extending portion 48a. Specifically described, the packing seal 60 is first inserted into the insertion hole 58 provided in the first extending portion 48a, and then the holder 62 is inserted into the insertion hole 58. Then, after the packing seal 60 and the holder 62 have been inserted into the insertion hole 58, the nut 56a is press-fitted into the first extending portion 48a whereby a state shown in FIG. 8 is established. In this state, the nut 56a is in contact at the surface 66 (in which the threaded hole 64 opens) with the busbar 50a.

As described above, when the gap is formed between the nut 56a and the busbar 50a, for example, at an extremely low temperature, if vibration generated in the stator 14 is transmitted to the busbar 50a via the stator power line cable 20a and the plate 36a, the busbar 50a is vibrated in right and left directions in drawing sheet of FIG. 8. In this instance, the amount of deformation of the vibrated busbar 50a is limited by the holder 62 that is inserted in the insertion hole 58.

If the holder 62 were not provided, the busbar 50a could be more displaced within in a range between the mutually opposed portions of the wall surface 58a of the insertion hole 58. On the other hand, in the present embodiment in which the holder 62 is provided, the gap defined between the busbar 50a and the wall surface 58a of the insertion hole 58 is practically reduced by an amount corresponding to the provision of the holder 62. Consequently, upon vibration of the busbar 50a, the busbar 50a is deformable only within a limited range, and the amount of deformation of the busbar 50a is limited by the holder 62. Therefore, even when the vibration is transmitted to the busbar 50a, the amount of deformation of the busbar 50a is limited and accordingly the load applied to the busbar 50a is reduced so that it is possible to suppress reduction of the durability of the busbar 50a. Moreover, since the amount of deformation of the busbar 50a is limited, it is possible to ensure sufficient squeeze (i.e., amount of compression) of the packing seal 60, thereby suppressing leakage of oil through the packing seal 60 and also entrance of water through the packing seal 60 from the outer space.

Further, since the holder 62 includes the projecting portion 62a projecting toward the nut 56a, the movement of the holder 62 in a direction toward the opening of the insertion hole 58 is limited to a range in which the distal end of the projecting portion 62a is not in contact with the nut 56a. Owing to the projecting portion 62a of the holder 62, the movement of the packing seal 60 that is disposed to be contiguous to the holder 62 is limited, too. Consequently, the packing seal 60 and the holder 62 are practically positioned by the projecting portion 62a, so that it is possible to prevent the packing seal 60 from being removed out through the opening of the insertion hole 58. It is noted that a length of the projecting portion 62a of the holder 62 is determined such that the distal end of the projecting portion 62a is normally spaced apart from the nut 56a without interfering with the nut 56a, and such that the packing seal 60 is not removed out of the insertion hole 58 when the distal end of the projecting portion 62a is in contact with the nut 56a.

Although detailed explanation is omitted, also in the insertion hole 58 which is provided in the second extending portion 48b and in which the busbar 50b is inserted, the holder 62 is inserted in a space defined between the busbar 50b and the wall surface 58a of the wall hole 58 and is disposed between the packing seal 60 and the opening of the insertion hole 58. Therefore, when the busbar 50b is vibrated, amount of deformation of the busbar 50b is limited by the holder 62 whereby durability reduction of the busbar 50b due to the deformation is suppressed and the oil leakage through the packing seal 60 and the water entrance through the packing seal 60 are suppressed.

Similarly, although detailed explanation is omitted, also in the insertion hole 58 which is provided in the third extending portion 48c and in which the busbar 50c is inserted, the holder 62 is inserted in a space defined between the busbar 50c and the wall surface 58a of the wall hole 58 and is disposed between the packing seal 60 and the opening of the insertion hole 58. Therefore, when the busbar 50c is vibrated, amount of deformation of the busbar 50c is limited by the holder 62 whereby durability reduction of the busbar 50c due to the deformation is suppressed and the oil leakage through the packing seal 60 and the water entrance through the packing seal 60 are suppressed.

As described above, in the present embodiment, the holder 62 is disposed in the gap defined between each of the busbars 50a-50c and the wall surface 58a of the insertion hole 58 and which is located between the packing seal 60 and the opening of the insertion hole 58. Therefore, even when the vibration generated in the rotary electric machine MG is transmitted to the busbars 50a-50c, the amount of deformation of each of the busbars 50a-50c is limited owing to contact of each of the busbars 50a-50c with the holder 62. Consequently, the load applied to each of the busbars 50a-50c is reduced so that it is possible to suppress reduction of durability of each of the busbars 50a-50c. Moreover, since the amount of deformation of each of the busbars 50a-50c is limited upon vibration of the busbars 50a-50c, it is possible to ensure sufficient squeeze of the packing seal 60, thereby suppressing leakage of oil through the packing seal 60 and also entrance of water through the packing seal 60.

Further, in the present embodiment, each of the nuts 56a-56c is press-fitted in a corresponding one of the first through third extending portions 48a-48c and is located on the side of the opening of the insertion hole 58, such that the surface 66 (in which the threaded hole 64 is provided) of each of the nuts 56a-56c is in contact with a corresponding one of the busbars 50a-50c. Therefore, with each of the bolts 34a-34c being provided to penetrate through a corresponding one of the busbars 50a-50c so as to be screwed in a corresponding one the nuts 56a-56c, it is possible to easily fix end portions of the busbars 50a-50c to the terminal block 39. Further, the holder 62 includes the projecting portion 62a projecting toward each of the nuts 56a-56c that is located on the side of the opening of the insertion hole 58, such that the distal end of the projecting portion 62a can be brought into contact with each of the nuts 56a-56c. Therefore, with the projecting portion 62a being brought into contact with each of the nuts 56a-56c, the movement of the holder 62 toward the opening of the insertion hole 58 is limited. Further, regarding the packing seal 60 disposed between the holder 62 and the bottom of the insertion hole 58, too, its movement toward the opening of the insertion hole 58 is limited, so that the packing seal 60 is prevented from being removed out of the insertion hole 58. Moreover, since the holder 62 is made of resin, it is possible to prevent the packing seal 60 being damaged by the holder 62 when the holder 62 and the packing seal 60 are brought into contact with each other.

While the preferred embodiment of this invention has been described in detail by reference to the drawings, it is to be understood that the invention may be otherwise embodied.

For example, in the above-described embodiment, the nuts 56a-56c are press-fitted in the respective first through third extending portions 48a-48c, and the bolts 34a-34c are screwed in the respective nuts 56a-56c, with each of the plates 36a-36c and a corresponding one of the busbars 50a-50c being superposed on each other and being clamped between a corresponding one of the bolts 34a-34c and a corresponding one of the nuts 56a-56c. However, the provision of the nuts 56a-56c is not essential. For example, each of the through-holes 54a-54c of the respective busbars 50a-50c may be modified to a threaded hole, so that the bolts 34a-34c are screwed in the thread holes of the respective busbars 50a-50c, with each of the plates 36a-36c and a corresponding one of the busbars 50a-50c being superposed on each other. In this modified arrangement, too, each of the busbars 50a-50c is brought into contact with the holder 62 when being vibrated, whereby amount of deformation of each of the busbars 50a-50c is limited.

Further, in the above-described embodiment, the holder 62 is made of resin. However, the holder 62 may be made of other material such as a metal material, as long as the material of the holder 62 is more rigid than a material of which the packing seal 60 is made.

It is to be understood that the embodiment described above is given for illustrative purpose only, and that the present invention may be embodied with various modifications and improvements which may occur to those skilled in the art.

### NOMENCLATURE OF ELEMENTS

14: stator
20a-20c: stator power line cables (power line cables)
22: connector
39: terminal block
50a-50c: busbars
56a-56c: nuts
58: insertion hole
58a: wall surface
60: packing seal (seal member)
62: holder (protection member)
62a: projecting portion
64: threaded hole
66: surface MG: rotary electric machine

What is claimed is:

1. A connector comprising:
a terminal block;
an elongated busbar which is inserted in an insertion hole provided in the terminal block so as to be held by the terminal block in a cantilever manner;
a seal member which is disposed between the busbar and a wall surface of the insertion hole and which closes a gap defined between the busbar and the wall surface of the insertion hole; and
a protection member which is disposed in the gap defined between the busbar and the wall surface of the insertion hole and which is located between the seal member and an opening of the insertion hole.

2. The connector according to claim 1, further comprising:
a nut having a surface in which a threaded hole is provided,
wherein the nut is press-fitted in the terminal block and is located on a side of the opening of the insertion hole, such that the surface of the nut is in contact with the busbar.

3. The connector according to claim 2,
wherein the protection member includes a projecting portion projecting toward the nut that is located on the side of the opening of the insertion hole.

4. The connector according to claim 1,
wherein the protection member is made of resin.

5. The connector according to claim 1,
wherein the busbar is to be connected to a power line cable extending from a stator of a rotary electric machine.

6. The connector according to claim 1,
wherein the protection member is made of a material that is more rigid than a material of which the seal member is made.

7. The connector according to claim 1,
wherein the busbar is an elongated plate member that is inserted in the seal member and the protection member each of which has a generally annular shape, and
wherein the protection member has an outside dimension that is smaller than a dimension of the insertion hole in which the seal member is fitted, each of the outside dimension of the protection member and the dimension of the insertion hole being a dimension measured in a thickness direction of the busbar that is the elongated plate member.
